(19) United States
(12) Patent Application Publication
(10) Pub. No.: US 2026/0229744 A1
(43) Pub. Date: Aug. 6, 2026

(54) SECONDARY BATTERY, METHOD OF MANUFACTURING ELECTRODE ASSEMBLY, AND METHOD OF MANUFACTURING SECONDARY BATTERY

(71) Applicant: SAMSUNG SDI CO., LTD., Yongin-si (KR)

(72) Inventors: Soyun KIM, Yongin-si (KR); Byunghuy CHO, Yongin-si (KR); Jeawoan LEE, Yongin-si (KR); Soo-Mi EO, Yongin-si (KR); Junho BYEON, Yongin-si (KR); Joonchul KIM, Yongin-si (KR); Hyojin LIM, Yongin-si (KR)

(21) Appl. No.: 19/459,082

(22) Filed: Jan. 26, 2026

(30) Foreign Application Priority Data
Feb. 3, 2025 (KR) 10-2025-0013002

(51) Int. Cl. H01M 50/586; H01M 10/04; H01M 50/176; H01M 50/466; H01M 50/54; H01M 50/595

(52) U.S. Cl. CPC H01M 50/586; H01M 10/049; H01M 50/176; H01M 50/466; H01M 50/54; H01M 50/595

(57) ABSTRACT

A secondary battery includes a case comprising a body part having an opening formed therein and a cover part covering the opening. A stacked electrode assembly is accommodated in the case, the electrode assembly including a first electrode connected to a first substrate tab, a second electrode connected to a second substrate tab, a separator between the first and second electrode, a first lead tab having an end coupled to the first substrate tab, and a second lead tab having an end coupled to the second substrate tab. The electrode assembly includes a first adhesive member covering a coupling region between the first substrate tab and the first lead tab, a second adhesive member wrapping at least one of side surfaces of the electrode assembly and a portion of at least one of main surfaces of the electrode assembly, a third adhesive member wrapping a lower surface of the electrode assembly and a portion of at least one of the main surfaces, and a fourth adhesive member attached in an inclined region.

### CROSS-REFERENCE TO RELATED APPLICATION

This present application claims priority to and the benefit under 35 U.S.C. §119(a)-(d) of Korean Patent Application No. 10-2025-0013002, filed on Feb. 3, 2025, in the Korean Intellectual Property Office, the entire disclosure of which is incorporated herein by reference.

### BACKGROUND

### Field

The present disclosure relates to a secondary battery, a method of manufacturing an electrode assembly, and a method of manufacturing a secondary battery.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

To prevent a short circuit in a substrate-tab region that electrically connects an electrode assembly and an electrode terminal of a secondary battery, an insulating plate may be positioned on an upper side of the electrode assembly. However, the insulating plate occupies volume and may reduce energy density per unit volume of the secondary battery. Fixing the insulating plate may also be difficult, and precisely extending a lead tab through a through-hole formed in the insulating plate may be challenging.

During insertion of an electrode assembly into a case of a secondary battery, an edge region of the separator that is larger than the electrodes may interfere with sealing of the case. Further, a lower surface of the electrode assembly is susceptible to impact inside the case when the secondary battery is dropped, so it is necessary to account for this potential problem to make the battery safter. In addition, during a formation process or similar processes of a secondary battery, pressure applied to the electrode assembly in a thickness direction is required to be uniform across an entire surface so that the electrode assembly is uniformly compressed.

The above information disclosed in this Background section is for enhancement of understanding of the background of the present disclosure, and therefore, it may contain information that does not constitute related (or prior) art.

### SUMMARY

The present disclosure provides a secondary battery, a method of manufacturing an electrode assembly, and a method of manufacturing a secondary battery that address the above-described issues.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to an embodiment of the present disclosure, a secondary battery includes a case comprising a body part having an opening formed therein and a cover part covering the opening, and a stacked electrode assembly accommodated in the case, the electrode assembly including a first electrode connected to a first substrate tab, a second electrode connected to a second substrate tab, a separator between the first electrode and the second electrode, a first lead tab having an end coupled to the first substrate tab, and a second lead tab having an end coupled to the second substrate tab and extending in the same direction as the first lead tab, wherein the electrode assembly includes a first adhesive member covering a coupling region between the first substrate tab and the first lead tab, the first adhesive member including an insulating material, a second adhesive member wrapping at least one of side surfaces of the electrode assembly and a portion of at least one of main surfaces of the electrode assembly, a third adhesive member wrapping a lower surface of the electrode assembly and a portion of at least one of the main surfaces of the electrode assembly, and a fourth adhesive member attached to at least one of the main surfaces of the electrode assembly in an inclined region where a thickness of a first electrode coating layer of the first electrode or a second electrode coating layer of the second electrode decreases relative to a thickness the first electrode coating layer or the second electrode coating layer at a center region of the electrode assembly.

In some embodiments, the electrode assembly may include first unit cells in which the first electrode and the separator are stacked, and second unit cells in which the second electrode and the separator are stacked, and the first unit cells and the second unit cells are alternately stacked.

In some embodiments, the second electrode may be a negative electrode arranged at an outermost side along a thickness direction of the electrode assembly, the case may include a metallic material and is electrically connected to the second electrode, the first electrode may be a positive electrode, and a first electrode terminal connected to an end of the first lead tab may be arranged at a side of the body part and exposed outside the body part, and the first electrode terminal and the case may be electrically insulated from each other.

In some embodiments, the electrode assembly further may include an insulating member surrounding a central portion of the first lead tab, the first substrate tab may include a first extension part extending in a first thickness direction of the electrode assembly to a bent portion, and a second extension part extending from the bent portion in a second thickness direction opposite to the first thickness direction, an end of the first lead tab is positioned between the first extension part and the second extension part, and the first adhesive member is disposed on a surface opposite a surface of the second extension part on which the first lead tab is disposed and a surface opposite to a surface of the first lead tab contacting the first extension part.

In some embodiments, a length of the first adhesive member along a width direction of the electrode assembly may be greater than or equal to a width of the first substrate tab, and a length of the first adhesive member along a thickness direction of the electrode assembly may be less than or equal to a thickness of the electrode assembly.

In some embodiments, the body part may include an accommodating part in which the electrode assembly is accommodated and a flange part extending from a periphery of the body part, and the cover part may be coupled to the flange part.

In some embodiments, the first adhesive member, the second adhesive member, the third adhesive member, and the fourth adhesive member may be one or more of a coating-type adhesive member, a film-type adhesive member, a gel-type adhesive member, a tape-type adhesive member.

In some embodiments, the separator may have an area greater than or equal to areas of the first electrode and the second electrode, and may include an edge region extending beyond the first electrode and the second electrode in a thickness direction of the electrode assembly, and the edge region in a length direction may be bent or folded toward the thickness direction of the electrode assembly by the second adhesive member.

In some embodiments, a length of the third adhesive member along a width direction of the electrode assembly may be less than or equal to a distance between second adhesive members attached to one of the main surfaces of the electrode assembly.

In some embodiments, a length of the fourth adhesive member along a width direction of the electrode assembly may be less than or equal to a distance between second adhesive members attached to one of the main surfaces of the electrode assembly.

In some embodiments, the fourth adhesive member may be attached at an upper edge where the first substrate tab and the second substrate tab are positioned on at least one of the main surfaces of the electrode assembly.

In some embodiments, the separator may have an area greater than or equal to areas of the first electrode and the second electrode and may include a region extending beyond with the first electrode and the second electrode in a thickness direction of the electrode assembly, and the region of the separator may be bent or folded toward the thickness direction of the electrode assembly by the third adhesive member.

In some embodiments, a method of manufacturing an electrode assembly includes preparing a laminate in which a first electrode connected to a first substrate tab, a second electrode connected to a second substrate tab, and a separator interposed between the first electrode and the second electrode are repeatedly stacked, coupling an end of a first lead tab to the first substrate tab and coupling an end of a second lead tab to the second substrate tab, attaching a first adhesive member including an insulating material to cover a coupling region between the first substrate tab and the first lead tab, attaching a second adhesive member to wrap at least one of side surfaces of the laminate and a portion of at least one of main surfaces of the laminate, attaching a third adhesive member to wrap a lower surface of the laminate and a portion of at least one of the main surfaces of the laminate, and attaching a fourth adhesive member to an inclined region where a thickness of a first electrode coating layer of the first electrode or a second electrode coating layer of the second electrode decreases relative to a thickness of the first electrode coating layer or the second electrode coating layer at a center region of the laminate.

In some embodiments, attaching the first adhesive member may include preparing the first adhesive member having a length in a width direction of the laminate that is greater than or equal to a width of the first substrate tab and a length in a thickness direction of the laminate that is less than or equal to a thickness of the laminate, clamping the first substrate tab in one direction by a guide while a first pusher and a second pusher having the first adhesive member fixed thereto to fix the first lead tab between the first pusher and the second pusher, bending the first substrate tab and the first lead tab while moving the second pusher toward the laminate, and removing the guide and attaching the first adhesive member to cover the coupling region between the first substrate tab and the first lead tab while moving the second pusher toward the laminate.

In some embodiments, the second pusher vacuum may adsorb the first adhesive member, and an adhesive layer of the first adhesive member may be attached to cover the coupling region between the first substrate tab and the first lead tab.

In some embodiments, bending the first lead tab may include fixing a first end of the first lead tab between a first extension part of the first substrate tab extending in a first thickness direction of the laminate and a second extension part of the first substrate tab extending in a second thickness direction opposite to the first thickness direction, and extending a second end of the first lead tab in a direction crossing the second extension part.

In some embodiments, attaching the second adhesive member may include rolling or folding the second adhesive member while pushing a separator exposed on at least one of side surfaces of the laminate in one direction.

In some embodiments, attaching the fourth adhesive member may include attaching the fourth adhesive member at an upper edge where the first substrate tab and the second substrate tab are positioned on at least one of the main surfaces of the laminate.

In some embodiments, attaching the third adhesive member may include rolling or folding the third adhesive member while pushing a separator exposed on a lower surface of the laminate in one direction.

In some embodiments, a method of manufacturing a secondary battery includes manufacturing the electrode assembly, inserting the electrode assembly into a body part having an opening, and coupling a cover part to the body part to cover the opening.

In some embodiments of the present disclosure, by means of the first adhesive member attached to the electrode assembly, insulation between the first substrate tab or the first lead tab and the case may be achieved without additionally occupying upper-side space of the electrode assembly.

In some embodiments of the present disclosure, a simple taping process using a first pusher, a second pusher, and a guide enables a precise and efficient attachment of the first adhesive member.

In some embodiments of the present disclosure, coupling between the body part and the cover part of the case may be improved by the second adhesive member attached to the electrode assembly.

In some embodiments of the present disclosure, the third adhesive member attached to the electrode assembly may make the secondary battery safer when the battery is dropped.

In some embodiments of the present disclosure, uniform pressing and heating of the secondary battery during a formation process or the like may be achieved without an additional process step by means of the fourth adhesive member attached to the electrode assembly, thereby improving cycle life characteristics and performance of the secondary battery.

In some embodiments of the present disclosure, more precise attachment may be achieved through a rolling process for the second adhesive member and the third adhesive member.

In some embodiments of the present disclosure, the above-described effects can be achieved without a decrease in gravimetric or volumetric energy density of the secondary battery merely through a simple taping process without adding separate components.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view of a secondary battery according to an embodiment of the present disclosure.

FIG. 2 is a cross-sectional view of the secondary battery of FIG. 1 taken along line XX′.

FIG. 3 is a view of an enlarged portion of the electrode assembly in region R of FIG. 2.

FIG. 4 is a view of a partial cross-section taken along a Y-axis direction of an electrode assembly according to an embodiment of the present disclosure.

FIG. 5 is a schematic view of adhesive-member attachment positions of an electrode assembly according to an embodiment of the present disclosure.

FIG. 6 is a flowchart of a method of manufacturing an electrode assembly according to an embodiment of the present disclosure.

FIG. 7 is a flowchart of a method of manufacturing a secondary battery according to an embodiment of the present disclosure.

FIGS. 8-13 are views of a method of manufacturing an electrode assembly according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in the present specification are intended to describe embodiments of the present disclosure and are not intended to limit the present disclosure.

Layers and regions shown in the drawings may be exaggerated in size and relative size for clarity of description. The sizes depicted in the drawings are merely for ease of understanding and are not limiting. Throughout the specification, identical reference numerals may designate identical components.

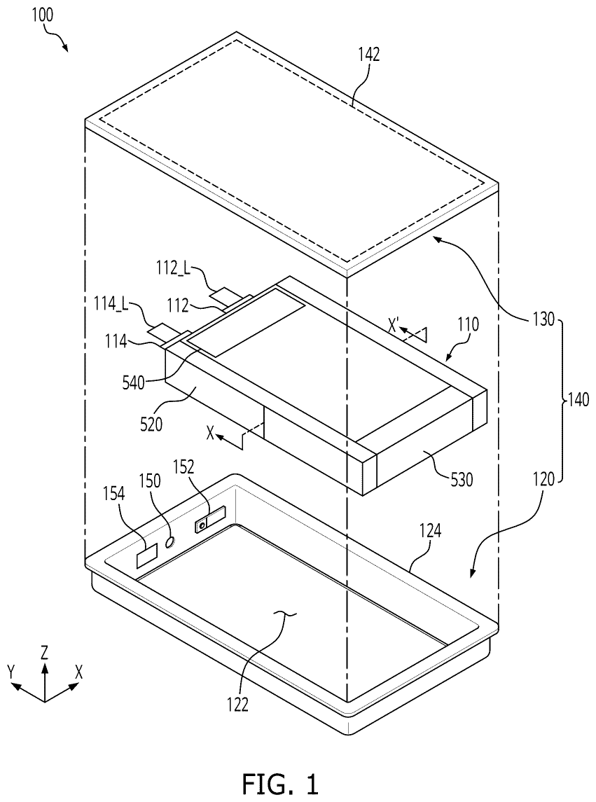

FIG. 1 is an exploded perspective view of a secondary battery according to an embodiment of the present disclosure.

A secondary battery 100 according to an embodiment of the present disclosure may include an electrode assembly 110, an electrolyte (not shown), and a case 140 in which the electrode assembly 110 and the electrolyte are accommodated.

The electrode assembly 110 may include a first electrode connected to a first substrate tab 112, a second electrode connected to a second substrate tab 114, and a separator interposed between the first electrode and the second electrode. An end of a first lead tab 112_L may be coupled to the first substrate tab 112, and an end of a second lead tab 114_L may be coupled to the second substrate tab 114.

The first electrode may function as a positive electrode, and the second electrode may function as a negative electrode. But, in other embodiments, the first electrode may function as a negative electrode and the second electrode may function as a positive electrode.

The first electrode may include a first electrode coating layer including a first electrode active material such as graphite or carbon, and/or a conductive material and a binder, with the first electrode coating lay being coated on one or two surfaces of a first substrate that is formed of a metal foil such as copper, a copper alloy, nickel, or a nickel alloy. The first electrode may further include a first non-coating region where the first electrode coating layer is not formed on the first substrate. The first substrate tab 112 may extend from a side of the first non-coating region. A first end of the first lead tab 112_L may be connected to the first substrate tab 112, and a second end of the first lead tab 112_L may be connected to the first electrode terminal 152 to form a current path between the first electrode and the first electrode terminal 152. In some examples, the first substrate tab 112 may be formed by cutting the first electrode to protrude from a side, and in other examples the first substrate tab 112 may protrude further than the separator without cutting.

The second electrode may include a second electrode coating layer including a second electrode active material such as a transition metal oxide, and/or a conductive material and a binder. The second electrode coating layer may be coated on one or two surfaces a second substrate that is formed of a metal foil such as aluminum or an aluminum alloy. The second electrode may further include a second non-coating region where the second electrode coating layer is not formed on the second substrate, and the second substrate tab 114 may extend from a side of the second non-coating region. A first end of the second lead tab 114_L may be connected to the second substrate tab 114, and a second end of the second lead tab 114_L may be connected to the second electrode terminal 154 to form a current path between the second electrode and the second electrode terminal 154. In some examples, the second substrate tab 114 may be formed by cutting the second electrode to protrude from a side, and in other examples the second substrate tab 114 may protrude further than the separator without additional cutting.

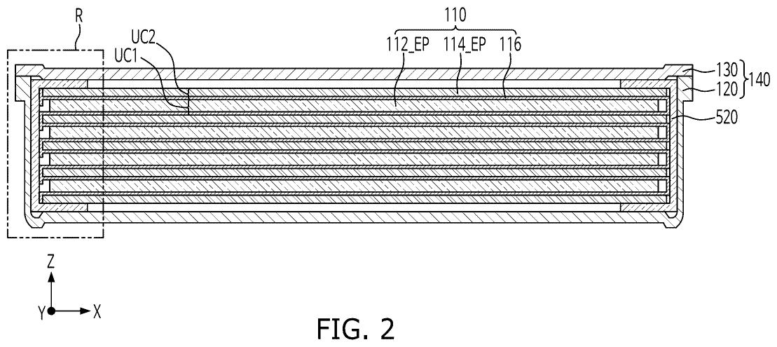

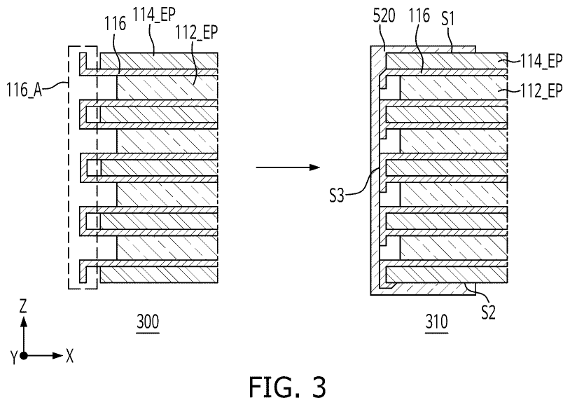

In the present disclosure, the electrode assembly 110 may be a stacked electrode assembly in which the first electrode, the separator, and the second electrode are sequentially stacked. Features of such an electrode assembly 110 will be described below with reference to FIGS. 2 and 3.

As illustrated in FIG. 1, the first lead tab 112_L and the second lead tab 114_L may be extend in the same direction from a surface of the electrode assembly 110, for example on an upper surface. A first end of the first lead tab 112_L may be welded and connected to a group of bound (or gathered) first substrate tabs 112 from a plurality of first electrodes included in the electrode assembly 110. A first end of the second lead tab 114_L may be welded and connected to a group of bound (or gathered) second substrate tabs 114 from a plurality of second electrodes. The, the stacked first electrodes may be electrically connected to the first electrode terminal 152, and the stacked second electrodes may be electrically connected to the second electrode terminal 154.

Referring to FIG. 1, the case 140 according to an embodiment may include a body part 120 including an accommodating part 122 in which the electrode assembly 110 is accommodated, a cover part 130 that seals an opening in the accommodating part 122, an electrolyte injection hole 150 formed in a side surface of the body part 120, and a plug (not shown) sealing the electrolyte injection hole 150.

The case 140 forms the exterior of the secondary battery 100, and may be formed of a conductive metal such as aluminum, an aluminum alloy, or nickel-plated steel. In some embodiments, the body part 120 and the cover part 130 may be formed of the same metallic material. The metallic material may include stainless steel (SUS) or aluminum (Al). However, the present disclosure is not limited thereto, and the case 140 may be formed of various metallic materials that provide sufficient strength and impact resistance.

The body part 120 may include the accommodating part 122 having an opening to accommodate the electrode assembly 110. Specifically, the accommodating part 122 may be formed with an internal space accommodating the electrode assembly 110 through a press process, a welding process, an adhesive process, or the like. A plan view shape of the accommodating part 122 of the case 140 may be, for example, rectangular, but is not limited thereto.

The body part 120 may include a flange part 124 extending from a periphery of an open end of the accommodating part 122. The cover part 130 may be coupled to the flange part 124 to seal the open side of the accommodating part 122. Specifically, the cover part 130 may be configured as a flat plate disposed on the flange part 124 to seal the open end of the accommodating part 122. More specifically, the cover part 130 may be formed as a flat plate having an area sufficient to cover the flange part 124 and may be in contact with the flange part 124. That is, a lower surface of the cover part 130 and an upper surface of the flange part 124 may face each other and be in contact. By coupling the flange part 124 and the cover part 130, the body part 120 and the cover part 130 may form an integral structure.

The case 140 may include a coupling line 142 disposed on the flange part 124 and the cover part 130 corresponding to the flange part 124. The coupling line 142 is a region in which the flange part 124 and the cover part 130 are coupled to seal the accommodating part 122. The coupling line 142 may include, for example, a region in which the flange part 124 and the cover part 130 are welded together by a laser welder. As another example, the coupling line 142 may include an adhesive region in which the flange part 124 and the cover part 130 are bonded to each other by an adhesive. The coupling line 142 may be formed along edges of the cover part 130 and the flange part 124.

The case 140 may further include a first electrode terminal 152 disposed on a side surface of the body part 120 and electrically connected to the first electrode of the electrode assembly 110. The case 140 may also include a second electrode terminal 154 disposed on a side surface of the body part 120 and electrically connected to the second electrode of the electrode assembly 110.

The electrolyte injection hole 150 is a through-hole for injecting electrolyte into the interior of the case 140. The electrolyte injection hole 150 connects the outside to the accommodation part 122 when the body part 120 and cover part 130 are joined and sealed. After the electrolyte is injected, the electrolyte injection hole 150 may be sealed or treated with sealing by a plug (not shown).

Referring to FIG. 1, the electrode assembly 110 according to an embodiment may include a first adhesive member 510 attached to cover the coupling region between the first substrate tab 112 and the first lead tab 112_L and including an insulating material. A second adhesive member 520 may wrap at least one of side surfaces of the electrode assembly and a portion of at least one of main surfaces of the electrode assembly 110. A third adhesive member 530 may wrap a lower surface of the electrode assembly and a portion of at least one of the end surfaces of the electrode assembly 110. A fourth adhesive member 540 may be attached to at least one of the main surfaces of the electrode assembly in an inclined region where a thickness of a first electrode coating layer of the first electrode or a second electrode coating layer of the second electrode decreases relative to a central thickness of the electrode assembly 110. Here, the main surfaces of the electrode assembly 110 include the upper surface shown in FIG. 1 and the opposite lower surface.

In the present disclosure, “attachment” may include any process of fixing a tacky material to a target surface. For example, attachment may include application of a coating-type tacky member.

The fourth adhesive member 540 may be attached on at least one of the main surfaces of the electrode assembly 110, for example, at an upper edge where the first substrate tab 112 and the second substrate tab 114 are located. Configurations of the respective adhesive members will be described below with reference to FIGS. 2-5.

In some embodiments, the second electrode functions as a negative electrode and is disposed at an outer side (or the periphery) along a thickness direction Z of the electrode assembly 110. The case 140 may be electrically connected to the second electrode and thereby have a negative polarity. In such embodiments, the first electrode functions as a positive electrode and is connected to the first substrate tab 112 by an end of the first lead tab 112_L, and a first electrode terminal 152 connected to the first lead tab 112_L may be disposed on a side of the body part 120 so as to be exposed outside the body part 120. An insulating material may be disposed between the first electrode terminal 152 and the case 140 so that they are electrically insulated from each other. Here, the second electrode terminal 154 may be the same polarity as the second electrode, similar to the case 140.

The second electrode that functions as a negative electrode (or a positive electrode) may be disposed at an outer side (or the periphery) along the thickness direction (Z direction) of the electrode assembly 110. Specifically, the second electrode may be disposed on at least a part of an outer side (or the periphery) of the electrode assembly 110. The remainder of the outer side (or the periphery) of the electrode assembly 110 may be formed by the separator. Therefore, the case 140 in contact with the second electrode disposed at the outer side (or the periphery) may acquire the polarity of the second electrode. In some examples, one of the main surfaces of the electrode assembly 110 may include the second electrode, and an opposite main surface may include the separator.

For reference, the X-direction, the Y-direction, and the Z-direction may respectively correspond to the width direction, the length direction, and the thickness direction of the electrode assembly 110 as shown in FIG. 1.

FIG. 2 is a cross-sectional view of the secondary battery of FIG. 1 taken along line XX′. FIG. 3 is a view of an enlarged portion R of the electrode assembly in FIG. 2. In FIGS. 2 and 3, the number of first unit cells UC1 is four and the number of second unit cells UC2 is five. But these numbers may vary depending on design capacity and energy density of the secondary battery.

Referring to FIG. 2, the electrode assembly 110 may be configured as a stack that includes a first unit cells UC1 in which the first electrode 112_EP and the separator 116 are stacked and second unit cells UC2 in which the second electrode 114_EP and the separator 116. The separator of the first unit cell UC1 and the separator of the second unit cell UC2 may be a single separator or separate separators. In the embodiment illustrated in FIG. 2, where one separator 116 is provided the first unit cells UC1 and the second unit cells UC2, the electrode assembly 110 may be a Z-stack electrode assembly in which the separator 116 folded in a Z-shape and has the first electrode 112_EP and the second electrode 114_EP provided at to opposite sides of the separator 116.

Referring to FIGS. 2 and 3, a second adhesive member 520 according to an embodiment may to wrap at least a portion of one of the main surfaces S1, S2 of the electrode assembly 110 and at least one of the side surfaces S3. A “portion of one of the main surfaces” may refer to a portion of surface S1 or a portion of opposite surface S2. The second adhesive member 520 may be disposed to not overlap with the third adhesive member and the fourth adhesive member, which will be described below, on surfaces S1 and S2 of the electrode assembly 110.

To prevent a short circuit due to contact between the first electrode 112_EP and the second electrode 114_EP, the separator 116 is may be made larger than the first electrode 112_EP and the second electrode 114_EP and is interposed between the first electrode 112_EP and the second electrode 114_EP. Accordingly, as shown in the view 300 depicted in FIG. 3 of the electrode assembly before attachment of the second adhesive member 520, the separator 116 included in the electrode assembly having an area greater than or equal to areas of the first electrode 112_EP and the second electrode 114_EP may include an edge region 116_A that extends beyond the first electrode 112_EP and the second electrode 114_EP along a thickness direction Z of the electrode assembly. The edge region 116_A may be formed on at least one of the side surfaces S3 of the electrode assembly.

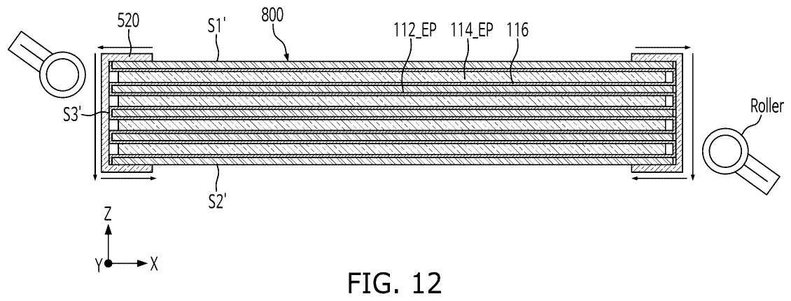

Referring to the view 310 of FIG. 3 depicting the electrode assembly after attachment of the second adhesive member 520, the edge region 116_A of the separator 116 may be bent or folded toward the thickness direction Z of the electrode assembly by the second adhesive member 520. Although the edge region 116_A may also be formed on a right-hand side surface of the electrode assembly 110 depicted in FIG. 2, the following description will be made with reference to region R depicted in FIG. 3. Each end of the plurality of parts of the separator 116 included in the edge region 116_A may be bent or folded in a positive Z direction or a negative Z direction, and an outer surface of the bent or folded parts may be covered and compressed by the second adhesive member 520. A specific bending process will be described below with reference to FIG. 12.

In the present disclosure, “bending” refers to an operation in which a target object is deformed into a curved shape by an external force and an inner surface and an outer surface of a bent portion are curved. “Folding” refers to an operation in which a target object is deformed along a distinct fold line by an external force and a folded structure is maintained in a planar or right-angle shape.

Referring again to FIG. 3, an enlarged view of the cross-section of the electrode assembly before the attachment of the second adhesive member 520, at least part of the separator 116 that protrudes by a predetermined length from the side surface S3 of the electrode assembly may extend into a region between the flange part (e.g., 124 in FIG. 1) of the body part and the cover part (e.g., 130 in FIG. 1), thereby making coupling difficult during sealing of the case 140. But, referring to enlarged view 310 after attachment of the second adhesive member 520, because the separator 116 protrudes by a predetermined length from the side surface S3 of the electrode assembly due to attachment of the second adhesive member 520, a likelihood of damage to the side surface S3 when inserting the electrode assembly into the case (e.g., 140 of FIG. 1) is reduced. Furthermore, when coupling the flange part (e.g., 124 of FIG. 1) of the body part and the cover part (e.g., 130 of FIG. 1), defects such as welding defects caused by an extension of protruding separator 116 into the coupling region may be eliminated.

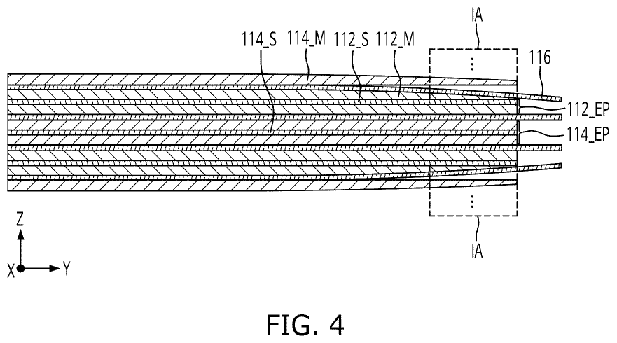

FIG. 4 is a view of a partial cross-section taken along a Y-axis direction of an electrode assembly according to an embodiment of the present disclosure. FIG. 4 explains an inclined region IA where the fourth adhesive member can be attached, and only portions of the electrodes and the separator are depicted for clarity.

A fourth adhesive member (e.g., 540 of FIG. 1) may be attached to at least one of the main surfaces of the electrode assembly 110 at an upper edge (or corner) where the first substrate tab 112 and the second substrate tab 114 are located. The upper edge may include the inclined region IA of the electrode assembly described below.

Referring to FIG. 4, the fourth adhesive member may be located on the inclined region IA in which a thickness decreases relative to a central thickness of the electrode assembly. Specifically, the inclined region IA may correspond to a region where a thickness of the first electrode coating layer 112_M of the first electrode 112_EP and/or a thickness of the second electrode coating layer 114_M of the second electrode 114_EP decreases relative to the central thickness of the electrode assembly. here, the thickness means a length in the Z-direction based on the electrode assembly depicted in FIG. 4.

The first electrode 112_EP may include the first substrate 112_S and the first electrode coating layer 112_M disposed on at least one surface of the first substrate 112_S. The second electrode 114_EP may include the second substrate 114_S and the second electrode coating layer 114_M disposed on at least one surface of the second substrate 114_S. The electrode coating layers 112_M and 114_M may be produced by coating electrode slurry on the substrates 112_S and 114_S and then drying the slurry. Due to surface tension of the slurry during the coating process, a peripheral region of the coating layer may become thinner than other regions. Alternatively, thickness imbalance of the electrodes may occur due to process variation during manufacturing of the electrode coating layers. An edge region of the electrode assembly containing at least part of such electrodes may become gradually thinner than other regions, and this phenomenon may be most pronounced at upper edges where the first substrate tab (e.g., 112 of FIG. 1) and the second substrate tab (e.g., 114 of FIG. 1) are located.

Because of the inclined region IA, the electrode assembly having a thinner upper edge than other regions may not be uniformly pressed or heated during a formation process that thermally presses the secondary battery. And during pressing of the secondary battery in a charge-discharge process, the upper edge that is relatively thin may create a relatively large free space in the case (e.g., 140 of FIG. 1) such that physical deformation of the case may occur. When the fourth adhesive member is attached at the upper edge, thickness at that region is reinforced and uniform pressing or heating may be achieved. Thus, when the fourth adhesive member is attached to the electrode assembly and the secondary battery is pressed, heated, or activated (formed), the electrode assembly may be uniformly pressed over an entire area of a surface orthogonal to the thickness direction Z, thereby improving cycle life characteristics of the secondary battery.

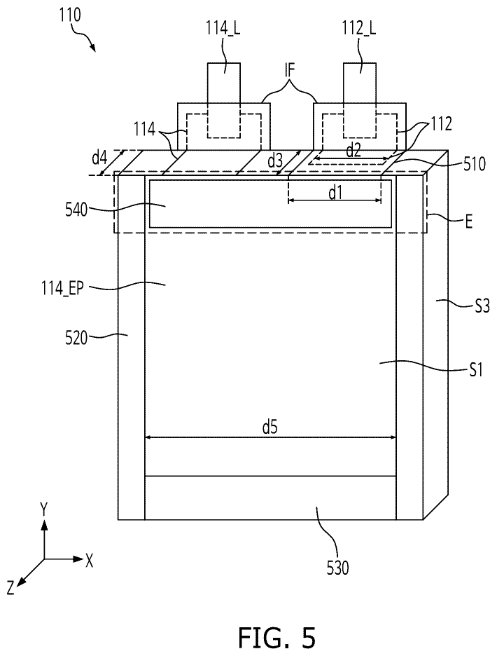

FIG. 5 is a schematic view of adhesive-member attachment positions of an electrode assembly according to an embodiment of the present disclosure.

In the present disclosure, an adhesive member may be a tacky region on one surface, and a surface opposite to that surface may not be made tacky. However, the adhesive member is not limited to this and both surfaces may be made tacky. The adhesive member may be a thin film or a film in which a coating agent is thinly applied and dried.

The adhesive members may be a coating-type adhesive member, a film-type adhesive member, a gel-type adhesive member, a tape-type adhesive member, or a combination thereof. A coating-type adhesive member may exhibit adhesiveness after liquid application and curing. A film-type adhesive member may be supplied by a roll and attached to the electrode assembly. A gel-type adhesive member, such as a silicone gel or an acrylic gel, may provide flexibility, high adhesiveness, and shock absorption. A tape-type adhesive member has an advantage of easy attachment because an adhesive is coated on one surface or both surfaces.

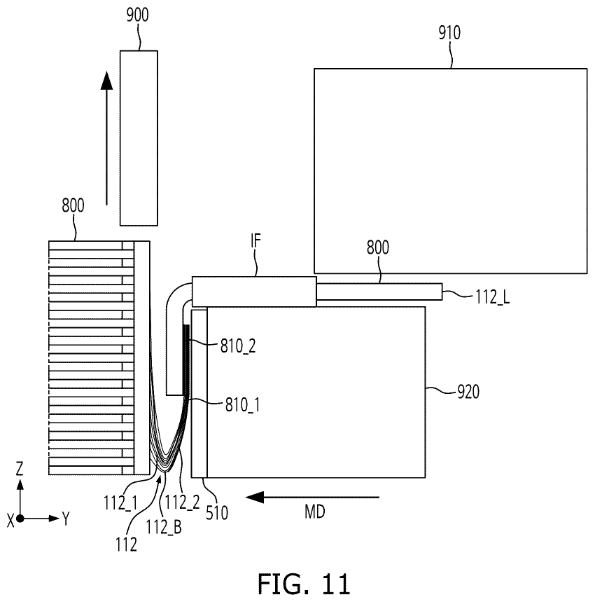

As illustrated in FIG. 5, an end of the first lead tab 112_L may be coupled to an end of the first substrate tab 112 so that the coupling region does not contact an upper surface of the electrode assembly 110. Alternatively, as will be described below with reference to FIG. 11, an end of the first lead tab 112_L may be disposed between two bent portions of the first substrate tab 112 and coupled thereto.

A first adhesive member 510 may be attached and cover the coupling region between the first substrate tab 112 and the first lead tab 112_L. Specifically, a region where the first substrate tab 112 or the first lead tab 112_L is disposed on an upper surface of the electrode assembly 110 may be covered by the first adhesive member 510. To make such a configuration, the first adhesive member 510 may descend from above the electrode assembly 110 in a direction toward the upper surface -Y direction - and may be easily attached on the upper surface of the electrode assembly 110. Details of a target attachment surface of the first adhesive member 510 will be described below with reference to FIG. 11.

A central portion of the first lead tab 112_L may be surrounded by an insulating member IF. Accordingly, one end of the first lead tab 112_L not covered by the insulating member IF may be connected to the first substrate tab 112, and the other end not covered by the insulating member IF may be connected to the first electrode terminal 152.

The first adhesive member 510 and the insulating member IF may be formed from insulating materials to thereby electrically insulate the first substrate tab 112 or the first lead tab 112_L from the case 140. For example, the first adhesive member 510 may be formed from polyimide, polyethylene terephthalate, polypropylene, or any combination thereof.

Referring to FIG. 5, in an embodiment, a length d1 of the first adhesive member along a width direction X of the electrode assembly 110 may be greater than or equal to a width d2 of the first substrate tab. A length d3 of the first adhesive member along a thickness direction Z of the electrode assembly 110 may be less than or equal to a thickness d4 of the electrode assembly 110. Accordingly, energy density is not reduced but the likelihood of a short circuit is reduced.

A thickness of the first adhesive member 510 in an embodiment may be less than thicknesses of the second adhesive member 520, the third adhesive member 530, and the fourth adhesive member 540. However, the present disclosure is not limited with respect to relative thicknesses of the adhesive members. That is, thicknesses of the adhesive members 510, 520, 530, 540 may be identical or different, and vary depending on the model or design of the battery. In a particular embodiment, the thickness of the first adhesive member 510 may be about 10 μm to about 30 μm.

A second adhesive member 520 may be attached so as to wrap at least one of the side surfaces S3 of the electrode assembly 110 and a portion of at least one of the main surfaces for example, surface S1. As described above with reference to FIGS. 2 and 3, the second adhesive member 520 may have a length in a length direction Y of the electrode assembly 110 that is greater than or equal to a long-side length of the separator 116 such that the second adhesive member 520 compressively covers all or part of the edge region 116_A of the separator. The long-side length of the separator 116 is a length in the Y-axis direction of the electrode assembly 110 depicted in FIG. 5.

A third adhesive member 530 may be attached so as to wrap a lower surface of the electrode assembly 110 and a portion of at least one of the main surfaces, for example, the surface S1 of the electrode assembly 110. The third adhesive member 530 may be a single integral adhesive member or be composed of a plurality of adhesive members. When the third adhesive member 530 is a single integral adhesive member, fixing of the electrode assembly may be stronger than when the third adhesive member 530 is composed of a plurality of adhesive members each wrapping a partial lower surface of the electrode assembly 110. When the third adhesive member 530 is composed of a plurality of adhesive members, the plurality of adhesive members may be made of one material or different materials and may wrap an entire or partial lower surface of the electrode assembly 110.

By attaching the third adhesive member 530 so as to wrap the lower surface of the electrode assembly 110 and a portion of at least one of the main surfaces, detachment of the first electrode, the second electrode, and the separator when the secondary battery is dropped may be prevented, thereby making the battery safer. Because the third adhesive member 530 wraps a portion of at least one (e.g., one surface S1) of the main surfaces of the electrode assembly 110, stacking and fixing of the first electrode, the second electrode, and the separator may be more robust.

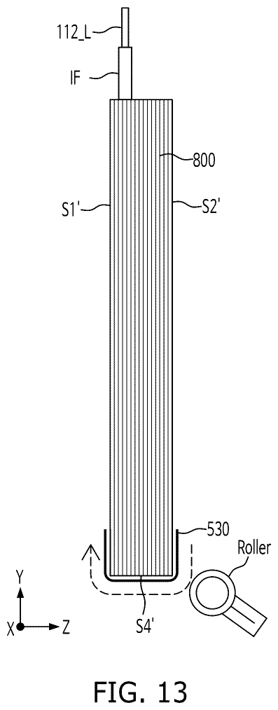

The separator may have an area greater than or equal to areas of the first electrode and the second electrode. The separator may include a region extends beyond the second electrode in the thickness direction of the electrode assembly. By attaching the third adhesive member to wrap the lower surface of the electrode assembly 110 and a portion of at least one of the main surfaces, the extended region may be bent or folded toward the thickness direction of the electrode assembly. As will be described below with reference to FIG. 13, the direction in which the extended region is bent or folded by the third adhesive member may be one direction.

A length of the third adhesive member 530 along a width direction X of the electrode assembly 110 may be less than or equal to a distance d5 between the second adhesive members 520 attached to the main surface S1 of the electrode assembly 110. As such, the third adhesive member 530 does not overlap the second adhesive member 520 and, thus, a decrease in energy density per volume and weakening of adhesive force of the second adhesive member 520 is avoided.

As described above with reference to FIG. 4, a fourth adhesive member 540 may be attached at an upper edge E of the electrode assembly 110 where the first substrate tab 112 and the second substrate tab 114 are provided on the main surfaces of the electrode assembly 110 (e.g., on the surface S1). A length of the fourth adhesive member 540 in the width direction X of the electrode assembly 110 may be less than or equal to the distance d5 between the second adhesive members 520 attached to the same surface S1. A length of the fourth adhesive member 540 in the length direction Y may be designed based on a size of the inclined region IA described above with reference to FIG. 4.

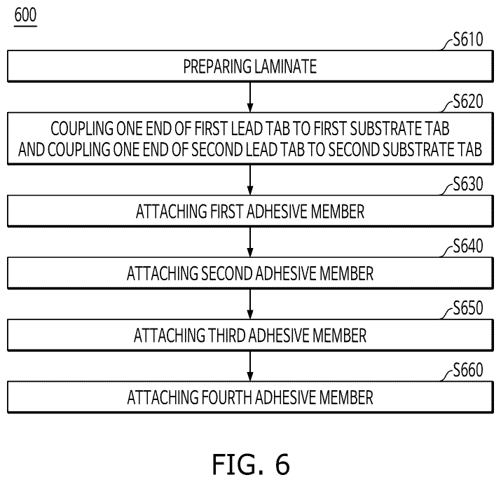

FIG. 6 is a flowchart of a method of manufacturing an electrode assembly according to an embodiment of the present disclosure. The term “laminate” refers to a configuration of the above-described electrode assembly before adhesive members are attached.

A method 600 of manufacturing an electrode assembly according to an embodiment of the present disclosure may start with step S610 of preparing a laminate in which a first electrode connected to a first substrate tab, a second electrode connected to a second substrate tab, and a separator interposed between the first electrode and the second electrode are repeatedly stacked. The laminate may, for example, be in a form in which first unit cells including the first electrode and the separator and second unit cells including the second electrode and the separator are alternately stacked. But the present disclosure is not limited thereto and any stacked electrode assembly may be used.

Next, step S620 an end of a first lead tab is coupled to the first substrate tab and an end of a second lead tab is coupled to the second substrate tab. The first substrate tab may refer to all first substrate tabs connected to the plurality of first electrodes included in the laminate. The second substrate tab may refer to all second substrate tabs connected to the plurality of second electrodes included in the laminate. The first substrate tab may refer to a group of first substrate tabs that are gathered and connected, and the second substrate tab may refer to a group of second substrate tabs that are gathered and connected.

Subsequently, in step S630 of a first adhesive member including an insulating material may be attached to cover the coupling region between the first substrate tab and the first lead tab, in step S640 of a second adhesive member may be attached to wrap at least one of the side surfaces of the laminate and a portion of at least one of the main surfaces of the laminate, in step S650 a third adhesive member may be attached to wrap a lower surface of the laminate and a portion of at least one of the main surfaces of the laminate, and in step S660 a fourth adhesive member may be attached to at least one of the main surfaces of the laminate at an upper edge where the first substrate tab and the second substrate tab are located. An order in which the respective adhesive members are attached is not limited in the present disclosure. However, as described above with reference to FIG. 5, adhesive members of predetermined sizes may be prepared according to length-limitation conditions of the respective adhesive members and may be attached in an order that allows easy attachment. For example, after attaching the second adhesive member, the distance d5 may be considered, and then the third adhesive member and the fourth adhesive member may be attached.

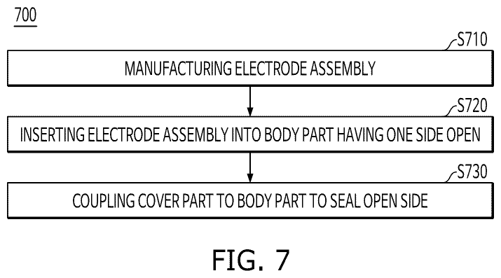

FIG. 7 is a flowchart of a method of manufacturing a secondary battery according to an embodiment of the present disclosure.

A method 700 of manufacturing a secondary battery according to an embodiment of the present disclosure may start with a step S710 of manufacturing an electrode assembly as described above with reference to FIG. 6. Thereafter, a step S720 of inserting the manufactured electrode assembly into a body part having an opening may be performed, and a step S730 of coupling a cover part to the body part to seal the open side of the body part may be performed.

The flowcharts in FIGS. 6 and 7 and the descriptions above are merely examples, and the scope of the present disclosure is not limited thereto. For example, one or more steps in the flowcharts and descriptions may be added, changed, or removed; an order of steps may be changed; or two or more steps may be performed simultaneously.

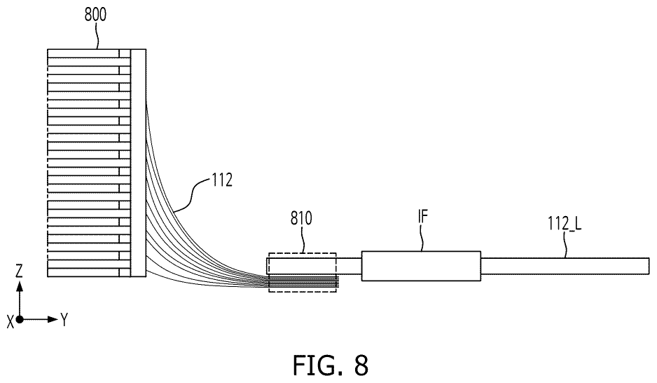

FIGS. 8-13 are views of a method of manufacturing an electrode assembly according to an embodiment of the present disclosure. FIGS. 8-11 illustrate a method of attaching the first adhesive member according to an embodiment of the present disclosure, FIG. 12 illustrates a method of attaching the second adhesive member according to an embodiment, and FIG. 13 illustrates a method of attaching the third adhesive member according to an embodiment of the present disclosure.

In an embodiment, attaching the first adhesive member may start with forming the first adhesive member whose length in a width direction X of a laminate 800 is greater than a width of the first substrate tab 112 in the X-direction and whose length in a thickness direction Z of the laminate 800 is less than a thickness of the laminate 800.

Referring to FIG. 8, a plurality of first substrate tabs 112 extending from a main surface of the laminate 800 may be gathered to form a first substrate-tab group and coupled to an end of the first lead tab 112_L, for example, by welding. Thus, an end of the first lead tab 112_L and the first substrate tab 112 may constitute part of a coupling region 810. Further, the central portion of the first lead tab 112_L may be covered or insulated by the insulating member IF, which may provide electrical insulation between the first lead tab 112_L and the case (such as the case 140 in FIG. 1).

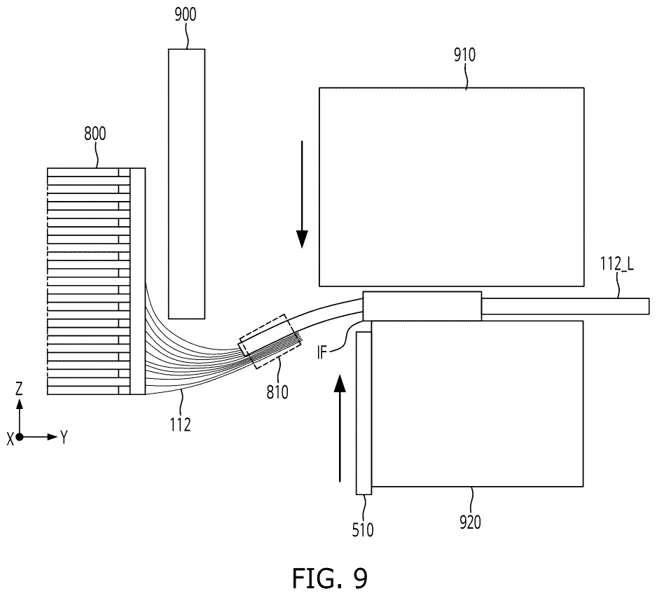

Referring to FIG. 9, attaching the first adhesive member 510 may include a step in which a guide 900 clamps the first substrate tab 112 in one direction (e.g., a negative Z direction) while the first lead tab 112_L is fixed between a first pusher 910 and a second pusher 920. In this state, the first adhesive member 510 may be fixed to the second pusher 920, as illustrated in FIG. 9. The second pusher 920 may hold the first adhesive member 510 by adsorption or attachment such that the first adhesive member 510 is fixed to a side of the second pusher 920. The first adhesive member 510 may be, for example, vacuum-adsorbed. Such adsorption applies when the first adhesive member 510 is tacky on both surfaces.

Each of the first pusher 910 and the second pusher 920 may move vertically and horizontally and may function to compress and deform a target object at a predetermined pressure or to couple different members. The shapes of the first pusher 910 and the second pusher 920 are not specially limited, but may be, for example, rectangular parallelepipeds. By adjusting relative positions of the first pusher 910 and the second pusher 920, an object fixed between the pushers 910 and 920 may be gripped or deformed. The first pusher 910 and the second pusher 920 may be operated by a drive unit not shown and controlled by a control unit not shown.

The guide 900 may be moved vertically by a separate drive unit or the above-mentioned drive unit and may be controlled vertically by a separate control unit or the above-mentioned control unit. “Up” and “down” are used here for convenience of description, and movement of the guide 900 may be performed left and right to accomplish the processes described herein.

As shown in FIG. 9, the first pusher 910 descends and the second pusher 920 ascends so that the first pusher 910 and the second pusher 920 fix the first lead tab 112_L therebetween. At the same time, the guide 900 descends in the negative Z direction and clamps the first substrate tab 112.

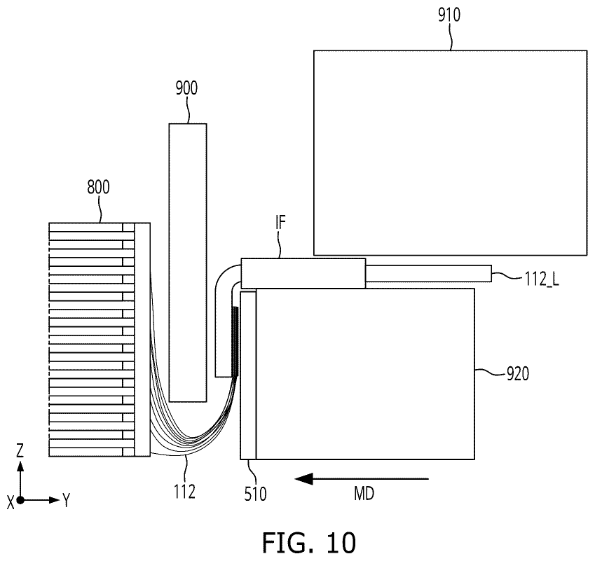

Referring to FIG. 10, attaching the first adhesive member 510 may include a step in which the second pusher 920 moves in a direction MD toward the laminate 800 and bends the first substrate tab 112 and the first lead tab 112_L. In this case, while the first pusher 910 remains fixed, the second pusher 920 may move horizontally in direction MD toward the laminate 800. Accordingly, the first adhesive member 510 may be attached on the first lead tab 112_L or the first substrate tab 112, which is disposed between the guide 900 and a side of the second pusher 920, by the pressing between the guide 900 and the side of the second pusher 920. Because the adhesive layer of the first adhesive member 510 is disposed on the side of the second pusher 920, attachment of the first adhesive member 510 may be easily accomplished so that the adhesive layer covers the coupling region (e.g., 810 in FIG. 9) between the first substrate tab 112 and the first lead tab 112_L.

Referring again to FIG. 10, the first lead tab 112_L, which is disposed and pressed between the descended guide 900 clamping the first substrate tab 112 and a side of the second pusher 920, may be bent to a shape of an edge of the side of the second pusher 920. For example, an end of the first lead tab 112_L may be bent to extend in the Y-direction, which is orthogonal to one main surface of the laminate 800. In the first lead tab 112_L, a bent portion may be anywhere between a portion covered by the insulating member IF and a portion coupled to the first substrate tab 112.

Referring to FIG. 11, attaching the first adhesive member 510 may include a step in which the guide 900 is removed and the first adhesive member 510 is attached to cover the coupling region 810 between the first substrate tab 112 and the first lead tab 112_L while the second pusher 920 moves in the direction MD toward the laminate 800. Removal of the guide 900 may be, for example, by ascending the guide 900. After removal of the guide 900, the first substrate tab 112 and the first lead tab 112_L may be fixed in a bent state. When vacuum adsorption of the first adhesive member 510 by the second pusher 920 is stopped, the adhesive layer of the first adhesive member 510 may attach the first adhesive member 510 on the first lead tab 112_L and the first substrate tab 112.

In an electrode assembly according to an embodiment, the first substrate tab 112 may include a first extension part 112_1 extending in a first thickness direction negative Z of the laminate 800 to a bending portion 112_B and a second extension part 112_2 extending from the bending portion 112_B in a second thickness direction positive Z opposite to the first thickness direction.

By the above-described operations of the first pusher 910, the second pusher 920, and the guide 900, an end of the first lead tab 112_L may be disposed between the first extension part 112_1 and the second extension part 112_2. The first adhesive member 510 may be disposed on a surface 810_1 opposite to a surface of the second extension part 112_2 where the first lead tab 112_L is disposed and on a surface 810_2 opposite to a surface of the first lead tab 112_L contacting the first extension part 112_1.

During bending of the first lead tab 112_L, an end of the first lead tab 112_L may be fixed between the first extension part 112_1 extending in a first thickness direction negative Z of the laminate 800 and the second extension part 112_2 extending in a second thickness direction positive Z opposite thereto. The other end of the first lead tab 112_L may extend in a direction crossing the second extension part 112_2. For example, as illustrated in FIG. 11, the other end of the first lead tab 112_L may extend in a direction orthogonal to the second extension part 112_2.

Referring to FIG. 12, attaching the second adhesive member 520 in an embodiment may include rolling the second adhesive member 520 while the second adhesive member pushes on a separator 116 that is exposed on at least one of the side surfaces S3′ of the laminate 800. Alternatively, attaching the second adhesive member 520 may include folding the second adhesive member 520. The direction in which the separator 116 is bent or folded may be as described above with reference to FIG. 3. A surface of the second adhesive member 520 may have an adhesive layer for easy attachment to the laminate 800. With the rolling process being performed during the attachment process, the second adhesive member 520 may be attached onto side surface S3′ and main surfaces S1′ and S2′ of the laminate 800 to provide a clean finish. As illustrated in FIG. 12, for each side surface S3′ of the laminate 800, a roller may be moved three times in directions of the depicted arrows to perform a precise rolling process. For example, for the second adhesive member 520 attached to the left side of the laminate 800, rolling may be performed along surface S1′ in the negative X direction, along side surface S3′ in the negative Y direction, and along surface S2′ in the positive X direction.

A direction in which the separator 116 is bent or folded may be one of directions toward surface S1′ or toward surface S2′ of the laminate 800, and is not limited to a particular direction. However, according to the rolling direction described above, the separator 116 may be bent or folded in one direction.

Referring to FIG. 13, attaching the third adhesive member 530 may include attaching and rolling or folding the third adhesive member 530 on a lower surface S4′ of the laminate 800 and on a portion of surface S1′ or surface S2′. The rolling direction may be one direction so that the separator exposed to the outside is bent or folded. For example, as illustrated in FIG. 13, a rolling process may be performed in the negative Y direction on surface S2′, in the negative X direction on lower surface S4′, and in the positive Y direction on surface S1′ of the laminate 800. Through this, the third adhesive member 530 may be more closely attached and not cause a significant increase in thickness.

By the rolling or folding processes described above, protrusion of the second adhesive member 520 and the third adhesive member 530 may be suppressed as much as possible and attachment may be accomplished more precisely.

Although not illustrated, various processes may be adopted so that the fourth adhesive member 540 can be precisely attached or applied to a desired position on a surface of the laminate 800. The fourth adhesive member 540 may be attached or applied using automation equipment that attaches with a constant pressure and speed. For example, the fourth adhesive member 540 may be evenly pressed using a roller or a press mechanism.

Although the present disclosure has been described above with respect to embodiments thereof, the present disclosure is not limited thereto. Various modifications and variations can be made thereto by those skilled in the art within the spirit of the present disclosure.

### DESCRIPTION OF SOME REFERENCE SYMBOLS

100: secondary battery; 110: electrode assembly; 112: first substrate tab; 114: second substrate tab; 112_L: first lead tab; 114_L: second lead tab; 120: body part; 122: accommodating part; 124: flange part; 130: cover part; 140: case; 142: coupling line; 152: first electrode terminal; 154: second electrode terminal; 150: electrolyte injection hole; IF: insulating member

What is claimed is:

1. A secondary battery comprising:
a case comprising a body part having an opening formed therein and a cover part covering the opening; and
a stacked electrode assembly accommodated in the case, the electrode assembly comprising a first electrode connected to a first substrate tab, a second electrode connected to a second substrate tab, a separator between the first electrode and the second electrode, a first lead tab having an end coupled to the first substrate tab, and a second lead tab having an end coupled to the second substrate tab and extending in a same direction as the first lead tab,
wherein the electrode assembly comprises:
a first adhesive member covering a coupling region between the first substrate tab and the first lead tab, the first adhesive member comprising an insulating material;
a second adhesive member wrapping at least one of side surfaces of the electrode assembly and a portion of at least one of main surfaces of the electrode assembly;
a third adhesive member wrapping a lower surface of the electrode assembly and a portion of at least one of the main surfaces of the electrode assembly; and
a fourth adhesive member attached to at least one of the main surfaces of the electrode assembly in an inclined region where a thickness of a first electrode coating layer of the first electrode or a second electrode coating layer of the second electrode decreases relative to a thickness of the first electrode coating layer or the second electrode coating layer at a center region of the electrode assembly.

2. The secondary battery as claimed in claim 1, wherein the electrode assembly comprises first unit cells in which the first electrode and the separator are stacked and second unit cells in which the second electrode and the separator are stacked, and
wherein the first unit cells and the second unit cells are alternately stacked.

3. The secondary battery as claimed in claim 1, wherein the second electrode is a negative electrode arranged at an outermost side along a thickness direction of the electrode assembly,
wherein the case comprises a metallic material and is electrically connected to the second electrode,
wherein the first electrode is a positive electrode, and a first electrode terminal connected to an end of the first lead tab is arranged at a side of the body part and exposed outside the body part, and
wherein the first electrode terminal and the case are electrically insulated from each other.

4. The secondary battery as claimed in claim 1, wherein the electrode assembly further comprises an insulating member surrounding a central portion of the first lead tab,
wherein the first substrate tab comprises a first extension part extending in a first thickness direction of the electrode assembly to a bent portion, and a second extension part extending from the bent portion in a second thickness direction opposite to the first thickness direction,
wherein an end of the first lead tab is positioned between the first extension part and the second extension part, and
wherein the first adhesive member is disposed on a surface opposite to a surface of the second extension part on which the first lead tab is disposed and a surface opposite to a surface of the first lead tab contacting the first extension part.

5. The secondary battery as claimed in claim 1, wherein a length of the first adhesive member along a width direction of the electrode assembly is greater than or equal to a width of the first substrate tab, and
wherein a length of the first adhesive member along a thickness direction of the electrode assembly is less than or equal to a thickness of the electrode assembly.

6. The secondary battery as claimed in claim 1, wherein the body part comprises an accommodating part in which the electrode assembly is accommodated and a flange part extending from a periphery of the of the part, and
wherein the cover part is coupled to the flange part.

7. The secondary battery as claimed in claim 1, wherein the first adhesive member, the second adhesive member, the third adhesive member, and the fourth adhesive member are each one or more of a coating-type adhesive member, a film-type adhesive member, a gel-type adhesive member, a tape-type adhesive member.

8. The secondary battery as claimed in claim 1, wherein the separator has an area greater than or equal to areas of the first electrode and the second electrode, and comprises an edge region extending beyond the first electrode and the second electrode in a thickness direction of the electrode assembly, and
wherein the edge region in a length direction is bent or folded toward the thickness direction of the electrode assembly by the second adhesive member.

9. The secondary battery as claimed in claim 1, wherein a length of the third adhesive member along a width direction of the electrode assembly is less than or equal to a distance between second adhesive members attached to one of the main surfaces of the electrode assembly.

10. The secondary battery as claimed in claim 1, wherein a length of the fourth adhesive member along a width direction of the electrode assembly is less than or equal to a distance between second adhesive members attached to one of the main surfaces of the electrode assembly.

11. The secondary battery as claimed in claim 1, wherein the fourth adhesive member is attached at an upper edge where the first substrate tab and the second substrate tab are positioned on at least one of the main surfaces of the electrode assembly.

12. The secondary battery as claimed in claim 1, wherein the separator has an area greater than or equal to areas of the first electrode and the second electrode and comprises a region extending beyond the first electrode and the second electrode in a thickness direction of the electrode assembly, and
wherein the region of the separator is bent or folded toward the thickness direction of the electrode assembly by the third adhesive member.

13. A method of manufacturing an electrode assembly, the method comprising:
preparing a laminate in which a first electrode connected to a first substrate tab, a second electrode connected to a second substrate tab, and a separator interposed between the first electrode and the second electrode are repeatedly stacked;
coupling an end of a first lead tab to the first substrate tab and coupling an end of a second lead tab to the second substrate tab;
attaching a first adhesive member comprising an insulating material to cover a coupling region between the first substrate tab and the first lead tab;
attaching a second adhesive member to wrap at least one of side surfaces of the laminate and a portion of at least one of main surfaces of the laminate;
attaching a third adhesive member to wrap a lower surface of the laminate and a portion of at least one of the main surfaces of the laminate; and
attaching a fourth adhesive member to an inclined region where a thickness of a first electrode coating layer of the first electrode or a second electrode coating layer of the second electrode decreases relative to a thickness of the first electrode coating layer or the second electrode coating layer at a center region of the laminate.

14. The method as claimed in claim 13, wherein attaching the first adhesive member comprises:
preparing the first adhesive member having a length in a width direction of the laminate that is greater than or equal to a width of the first substrate tab and a length in a thickness direction of the laminate that is less than or equal to a thickness of the laminate;
clamping the first substrate tab in one direction by a guide while a first pusher and a second pusher having the first adhesive member fixed thereto to fix the first lead tab between the first pusher and the second pusher;
bending the first substrate tab and the first lead tab while moving the second pusher toward the laminate; and
removing the guide and attaching the first adhesive member to cover the coupling region between the first substrate tab and the first lead tab while moving the second pusher toward the laminate.

15. The method as claimed in claim 14, wherein the second pusher vacuum adsorbs the first adhesive member, and
wherein an adhesive layer of the first adhesive member is attached to cover the coupling region between the first substrate tab and the first lead tab.

16. The method as claimed in claim 14, wherein bending the first lead tab comprises:
fixing a first end of the first lead tab between a first extension part of the first substrate tab extending in a first thickness direction of the laminate and a second extension part of the first substrate tab extending in a second thickness direction that is opposite to the first thickness direction; and
extending a second end of the first lead tab in a direction crossing the second extension part.

17. The method as claimed in claim 16, wherein attaching the second adhesive member comprises rolling or folding the second adhesive member while pushing a separator exposed on at least one of side surfaces of the laminate in one direction.

18. The method as claimed in claim 13, wherein attaching the fourth adhesive member comprises attaching the fourth adhesive member at an upper edge where the first substrate tab and the second substrate tab are positioned on at least one of the main surfaces of the laminate.

19. The method as claimed in claim 13, wherein attaching the third adhesive member comprises rolling or folding the third adhesive member while pushing a separator exposed on a lower surface of the laminate in one direction.

20. A method of manufacturing a secondary battery, the method comprising:
manufacturing the electrode assembly according to the method of claim 13;
inserting the electrode assembly into a body part having opening; and
coupling a cover part to the body part to cover the opening.
